(19) United States
(12) Patent Application Publication
(10) Pub. No.: US 2009/0167769 A1
(43) Pub. Date: Jul. 2, 2009

(54) METHOD, DEVICE AND SYSTEM FOR MANAGING STRUCTURE DATA IN A GRAPHIC SCENE

(75) Inventors: Erwann Gouesbet, Saint-Domineuc (FR); Elouan Le Coq, Rennes (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Streamezzo, Paris (FR)

(21) Appl. No.: 12/293,379

(22) PCT Filed: Mar. 16, 2007
(86) PCT No.: PCT/EP07/52545

§ 371 Date: Feb. 9, 2009

(30) Foreign Application Priority Data
Mar. 17, 2006 (FR) 0602426

(51) Int. Cl. G06F 13/14

(52) U.S. Cl. 345/473

(57) ABSTRACT

A method is provided for restoring graphic animation content including the following steps: in a receiver terminal; transmitting a request for retrieving the content; and obtaining at least one graphic scene of the content describing at least the spatio-temporal arrangement between the graphic objects of the content. The content further includes at least one function for managing structured data allowing interaction with a database of structured data. The method further includes: querying the database, based on at least one command present in the graphic scene and associated with the functions(s) for managing structured data; obtaining structured data derived from the database; integrating the structured data in the graphic scene; and restoring the graphic scene.

### CROSS-REFERENCE TO RELATED APPLICATIONS

This Application is a Section 371 National Stage Application of International Application No. PCT/EP2007/052545, filed Mar. 16, 2007 and published as WO 2007/107534 on Sep. 27, 2007, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The disclosure relates to the access and transmission of contents and, more precisely, graphic animations, between client terminals acting as receivers, such as radio-telephones, electronic organisers (PDAs), etc. and servers of such contents.

More precisely, the disclosure applies to a large number of applications, for example of the Rich Media type, which require a description of the spatio-temporal arrangements between the graphic objects defining a graphic animation content to be taken into account so that the behaviour of a graphic scene of a given application is perfectly rendered on the client terminal (called the receiver).

It should be noted that the technique of the disclosure may be applied without restriction to all types of graphic animation descriptions that currently exist, especially MPEG-4/BIFS, SVG, SMIL, XHTML etc.

By way of preliminary remark, it should be noted that for reasons of clarity of the description, a certain number of items of technical data have been grouped in an Appendix. Of course all of the information which appears in the various appendices is an integral part of this disclosure.

### BACKGROUND OF THE DISCLOSURE

At present, several techniques are known which permit the simultaneous processing of a structured data base and a graphic scene based on such structured information and on a series of simple instructions permitting certain tasks to be automated and to define the behaviour of the graphic objects in the scene.

A major disadvantage of the use of such instructions is that they are part of a programming language (or script) that must be first interpreted or compiled, which is to say that it must first be translated into a binary language that may be understood directly by the processor of the terminal onto which the graphic animation is to be rendered.

By way of non-restrictive illustrative example, such a disadvantage today represents an obstacle to the possibility of receiving on a receiver terminal structured information that is representative for example of an electronic program guide available from a digital television server and to the direct presentation of this guide in the form of a corresponding graphic animation, on the receiver terminal which requires the display of such a guide.

Indeed, the entire program guide cannot be taken into consideration using solutions of the prior art without modifying the programming and/or design of the player of the terminal. Furthermore, the information contained in this program guide cannot be taken into consideration in a single block of information, which has the additional disadvantage of implying on the contrary the iterative taking into consideration of the information contained in the program guide, which has the consequence of the risk of desynchronisation of the information available on the server at an instant t and the rendering of the latter on the receiver terminal at an instant t+dt.

The “LASeR and SAF editor's study” document, INTERNET CITATION July 2005, XP002394535 discloses an architecture, a format of scene description, an aggregation format, profiles and various sections including a formal description of binary encoding. In the scene description section, there are sub-sections on the temporal model, the execution model, the events, the binary encoding, the update commands and the elements of the scene description. However, this document does not describe any means of including external information, that is not graphic scene information, into the graphic scene, as is the case of an embodiment of this invention.

Finally, the “An MPEG standard for rich media services” document, IEEE Multimedia USA, vol. 12, n^{o} 4, October 2005, XP002412761, makes a general presentation of the LASeR standard. This document explains what a rich media service is, the main functions of LASeR, the portal applications, interactive mobile television, the screensaver, the LASeR components with the initial SVG type scene, scene extensions, scene updates, binary encoding, the audiovisual support, the fonts, incremental scenes, aggregation format and the cache mechanism.

In this document, an aspect is described of a service updated by the server wherein all of the information is available in a LASeR format, which means that all of the information are from the graphic scene field, contrary to an embodiment of this invention which proposes the simultaneous processing of a graphic scene and a structured information data base.

### SUMMARY

An aspect of the disclosure relates to a method for managing a plurality of structured information received by a client terminal, called a receiver, in response to a request to collect graphic animation content from a server terminal of such contents.

According to an embodiment of the invention, such a method advantageously comprises the following steps:
the emission of a retrieval request of at least one graphic animation content by said client terminal, destined to said content server terminal;
retrieval by said client terminal of at least one descriptive file of said graphic animation content, wherein said file describes the spatio-temporal arrangement between the graphic objects of said animation content and comprises at least one structured information management function that may automate:
   the creation and execution of the attribution request of at least one given value to at least one attribute of at least one of said graphic objects and/or
   the creation and execution of at least one interaction value with at least one of said graphic objects,

and which takes into account said plurality of structured information.

The structured information management functions interrogate the data base containing the plurality of structured information (for example that concerning the taking into account or the integration into a graphic animation content or a multimedia scene, of an electronic program guide). It permits a semantic information model and an information presentation model to be connected on a client receiver terminal.

Such an approach according to the method according to an embodiment of the invention further advantageously dispenses the need for any script mechanism and any reprogramming of a content to be rendered onto a terminal requiring it.

The method further advantageously permits the rendering of a graphic animation content to be synchronised on the client terminal, by means of a determinist model formed by the plurality of structured information taken into account by the management functions, which are directly integrated into the descriptive file of the animation content or the multimedia scene.

In one advantageous embodiment of the invention, said plurality of structured information is stored in a memory of said receiver terminal.

In a variant of the method according to an embodiment of the invention, said plurality of structured information is received by said receiver terminal from an independent structured information management server relative to a plurality of graphic animation contents.

In this embodiment, the structured information management functions take into account an addressing link (preferably a URL) pointing to the various structured information to be used to render a predetermined graphic content, wherein the former is hosted on the independent structured information management server.

In one variant of the invention, the independent structured information management server and the graphic animation content server may be grouped together as one server.

More precisely, an embodiment of the invention relates to a method for rendering a graphic animation content comprising the following steps, in a receiver terminal:
emitting a request to retrieve said content;
obtaining at least one graphic scene of said content, describing at least the spatio-temporal arrangement between the graphic objects of said content.

According to an embodiment of the invention, said content also comprises at least one function for managing structured information which permits the interaction with a structured information data base, and wherein said method comprises the following steps:
interrogation of said data base, in function of at least one command present in said graphic scene and associated to said structured information management functions;
obtaining structured information from said data base;
integration of said structured information into said graphic scene;
rendering of said graphic scene.

Consequently, the method according to an embodiment of the invention permits the integration of structured information into a graphic scene, collected from a data base, which is to say information that is different from the descriptive information of the graphic scene, and of which the structure is already known.

According to one variant of the invention, said content and/or said structured information may be located in said terminal. Therefore the structured data base may be found in the terminal following a download prior to the rendering of the graphic scene.

According to another variant, said content and/or said structured information are stored in at least one remote server. Consequently, the rendering method according to this variant interrogates one or several remote servers, on which are hosted the graphic contents and the structured information data base.

Preferably, said structured information is stored on a dedicated server that is distinct from the content server(s).

According to one specific embodiment, the rendering method comprises a step for configuring a filter, initiated by one of the commands, which defines a sub-assembly of said structured information data base, comprising the information that needs to be presented.

Consequently, the method according to an embodiment of the invention permits the filtering of the structured information data to be loaded in function of the graphic scene to be rendered.

Advantageously, the rendering method of an embodiment of the invention comprises at least one loading step, initiated after the filter configuration step, which defines the nature and the number of items of structured information data to be loaded.

Advantageously, said loading step is preceded by a step for positioning an index, initiated by a command which defines the loading order for the structured information data to be loaded.

Consequently, after defining the sub-assembly of information to be presented, via a filter, a command allows the positioning of an index which defines the order of the data to be loaded, in a data loading step. This data loading step has parameters which define the nature and number of the items of data to be loaded.

Preferably, the rendering method according to an embodiment of the invention comprises:
a step for detecting the successful loading of the structured information data, generating success information;
a step for updating said content upon receipt of the success information.

Consequently, the method detects if the loading has been carried out correctly before updating the graphic scene with the data loaded.

In this case (successful loading), said update step comprises a step for attributing data loaded to a field of an object of said graphic scene.

Consequently, the objects of the graphic scene are updated, by attributing the data loaded to the corresponding fields, so as to integrate the structured information into the graphic scene.

Furthermore, in the case of the detection of the success of the last item of data to be loaded, the method comprises a step for adding into the graphic scene an interactive signal element which permits a user of said terminal to receive a signal that it is possible to load the additional structured information data.

Consequently, once the last item of data has been successfully loaded, an additional element is added to the graphic scene, which makes it possible to signal to a user of the terminal that additional data may be loaded. Such an element may be for example an arrow indicating to the user that it is possible to access additional information by clicking on the arrow.

In the case of a failure of the loading of the structured information data being detected, the method comprises a step for updating said content, providing an item of information that is representative of said failure. For example, the graphic scene may be updated by displaying in the place of where the structured information should have been integrated a sign indicating to the user that the information cannot be accessed.

### BRIEF DESCRIPTION OF THE DRAWINGS

Other features and advantages will become clearer upon reading the following description of a preferred embodiment, provided simply by way of illustrative and non-restrictive example, and appended drawings, among which:

FIG. 1 shows an example of architecture and flow exchange between the various elements of the structured information transmission and management system in a graphic scene;

FIG. 2 shows two examples of host contents for information imported from a structured information base;

FIG. 3 shows the different steps of the method according to a specific embodiment of the invention.

### DETAILED DESCRIPTION OF ILLUSTRATIVE EMBODIMENTS

The general principle of an embodiment of the invention is therefore based on a method which permits a structured information to be integrated into a graphic scene (or graphic animation content) that is to be rendered on a client receiver terminal.

An embodiment of the invention may be especially used in a large number of applications, which require a description of spatio-temporal arrangements of graphic objects to represent the graphic behaviour of said applications and a structured information data base updated regularly to valorise the graphic objects and interact on their behaviour and thus semantically present the information to a user.

The purpose of an embodiment of the invention consists therefore of describing a device for the transmission, decoding and processing of structured information management functions (which do not provide graphic indications) in graphic scenes (or graphic animation contents).

Many cases require the use of graphic scenes to present structured information on a terminal that is sent to this terminal by different means.

According to an embodiment of the invention, structured information management functions (called FGIS by the inventors) in graphic scenes, described in this document, permit the management of:
requests for the valorisation of graphic objects by structured information, wherein the purpose of these valorisation requests is to attribute at least one value to at least one attribute of a graphic object contained in the scene or the graphic animation content (for example: determining the size of a rectangle object, changing the colour of an object, telling an object if it is to be visible or invisible, transparent, etc.);
series of simple instructions (of variable structuring levels), permitting the automation of the execution of these requests, their transmission and further use in several graphic scenes. Such a relatively “low level” representation of the “management” functions permits fine interaction between the graphic scenes and the structured information sent.

The technique according to an embodiment of the invention advantageously permits easier maintenance on the creation of graphic animation contents.

In particular, the use of a mechanism integrated into the graphic command rendering process permits heavy dependence between the content and the use of structured information and does not require any additional debugging process (i.e. searching and removing any errors if possible) to validate the valorisation requests (i.e. to attribute at least one value to at least one attribute of the graphic object in question) and to interact with the graphic objects.

The following scenario provides an example of an implementation of the invention in a given application context:
a receiver asks a graphic animation content from the source (server A),
the server returns a content which describes the spatio-temporal arrangement of the graphic objects, in the form of a structured information block,
in this last content, structured information management functions (FGIS) are integrated and described. The latter may be arranged as a series of simple instructions that can enable the automation of the valorisation and interaction requests targeting at least certain graphic objects of the graphic animation content required by the receiver (client terminal).

They especially indicate that a set of structured information stored in memory in the receiver will be accessible or not and that, if applicable (i.e. valorisation and interaction on a graphic object), a processing will be carried out.
the structured information is received by the receiver via a server (server B) which may be independent from server A.

Different commands may be used to modify a set of properties of a scene at a given instant.

The commands that must be executed at a precise instant by the graphic scene are described as URLs activated following user interaction.

In the aim of modifying the appearance of the graphic scene, the graphic objects to be valorised or which may be the subject of an interaction, must be referenced by a unique key (called ID or DefName depending on the graphic scene representation techniques).

Such commands permit the types of information used by the scene to be defined and the nodes of the latter which receive this information.

They especially comprise a list of elements required to obtain the structured information integrated into a multimedia scene description or in a graphic animation content.

An example of syntax and semantics of such a command is provided by way of example: cmd://<action>?<xxx>=<nnnn>&<yyyy>=<pppp>& . . .

Where:
<action> defines the type of interrogation of the base (or block) of structured information;
<xxxx> and <yyyy> represent the types of information to be searched;
<nnnn> and <pppp> represent the elements of this type of information.

Another example of node definition of a graphic scene is also provided by way of example:
cmd://<action>?<xxxx>=<nnnn>& . . . &idT=<yyyy>&idA<<zzzz>

Where:
<action> defines the type of action to be carried out on the graphic objects;
<yyyy> is the graphic object to be modified;
<zzzz> is the graphic object with which interaction is necessary if the information exists.

Below is an example of implementation of an embodiment of the invention.

The operation of the structured information management method in the graphic scene may be described according to the following steps, considering FIG. 1:

1. Entry of the graphic scene descriptive data and structured information via network connections or by reading files;

2. Decompression of this data in order to obtain a description of the graphic objects that may be directly used by an audio and graphic rendering engine;

3. Possible decompression of this data in order to obtain a description of the structured information elements that may be used directly by the modules interrogating the structured information base;

4. Composition of the graphic objects between themselves to create a graphic scene;

5. Activation of the commands describing the structured information management functions (FGIS) depending on the execution model used by the rendering engine (refer to FIG. 1);

6. Processing of the commands describing the FGIS (refer to FIG. 1);

7. Rendering (i.e. display of visual objects or playing a sound) of the audio and graphic objects;

8. Taking into account the user interactions (i.e. mouse click, pressing a key, etc.) and recording of any activations of the FGIS;

9. Creating a connection to a local or remote information source if required;

10. Return to 1 if no stop mechanism is activated.

Consequently, following a request from a user, the system according to an embodiment of the invention will open a connection to the server and recover a binary flow.

This binary flow will be analysed by the player which will then create the graphic scene that will contain the text elements to be rendered.

If a URL contains a command containing FGIS is analysed in the binary flow, then the player records this and executes the FGIS before rendering the next representation of the graphic scene on the receiver (e.g. direct representation of the pixels on the screen).

Such a novel and inventive approach is of particular interest in that it permits a block of structured information required for the rendering of the next representation of a graphic scene on the receiver to be taken into account at the player, without having to re-program the player and consequently completely generically. All of the design of a multimedia scene or a graphic animation content is henceforth carried out directly in the scene or the animation content.

As summarised in FIG. 1, the operation of the FGIS management method and system according to an embodiment of the invention may be resumed by the following steps:

1. Recovery of structured information instructions from the rendering device.

2. Establishing a connection to a local or remote information source if required.

3. Interrogation of the structured information base and storage of the responses to the requests.

4. Waiting for and processing of the commands describing the FGIS (refer to step 6 of the rendering mentioned above).

5. Return to 1 if no stop mechanism is activated.

The method and system according to an embodiment of the invention advantageously permit graphic scenes or graphic animation contents, for example of the rich Media type, to be conferred with the possibility of accessing structured information, by providing them with new commands directly in their description, commands which will then be directly read and interpreted by a rendering engine, for example a CBMS engine (according to the CBMS standard of the same name, for Convergence Broadcast Mobile Services).

Such a method advantageously further makes it possible:
to dispense with the constraint of programming, all of the graphic rendering of a scene is henceforth integrated into the descriptive file of the scene;
to dispense with any hard coding constraints of the scene, especially as concerns certain categories of graphic objects;
to be no longer constrained by the management of a limited and predetermined number of graphic objects in a scene.

According to an embodiment of the invention, a multimedia scene or a graphic animation content is henceforth capable of:
defining filters on data;
creating a selection of one or several objects by the use of a previously defined filter;
loading into the scene graphic objects thus indexed on the selection made;
modifying one or several indexes of the selection;
searching for attribute values for a selected object;
testing the value of an attribute of a given object.

The various steps of the method will now be described in relation to FIG. 3, according to one specific embodiment of the invention.

The first step of emitting a request 31 consists of emitting a request to recover a graphic content from a server of such contents.

In response to this request, the terminal receives at least one graphic scene of the content requested, comprising, in addition to the spatio-temporal arrangement information between the graphic objects, structured information management functions.

Thanks to these structured information management functions, the method interrogates, during an interrogation step 33, a structured information data base, by means of a command present in the scene.

The sub-steps 331 to configure a filter defining the data loading 332 and loading request 333, that are part of step 33, consist of selecting, from the structured information of the data base 334, the information required to update the graphic scene in question then to load them in a predefined order.

In function of the result (success or failure) of the data loading, the method updates the graphic scene, in updating steps 341 or 342 then renders it in a rendering step 35.

Consequently the rendering method permits structured information to be integrated into a graphic scene.

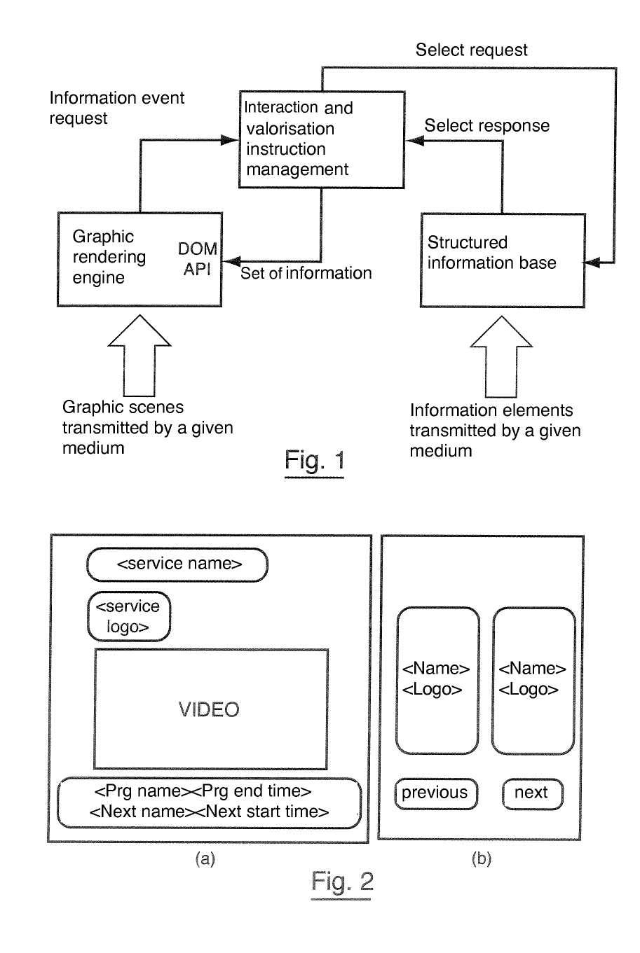

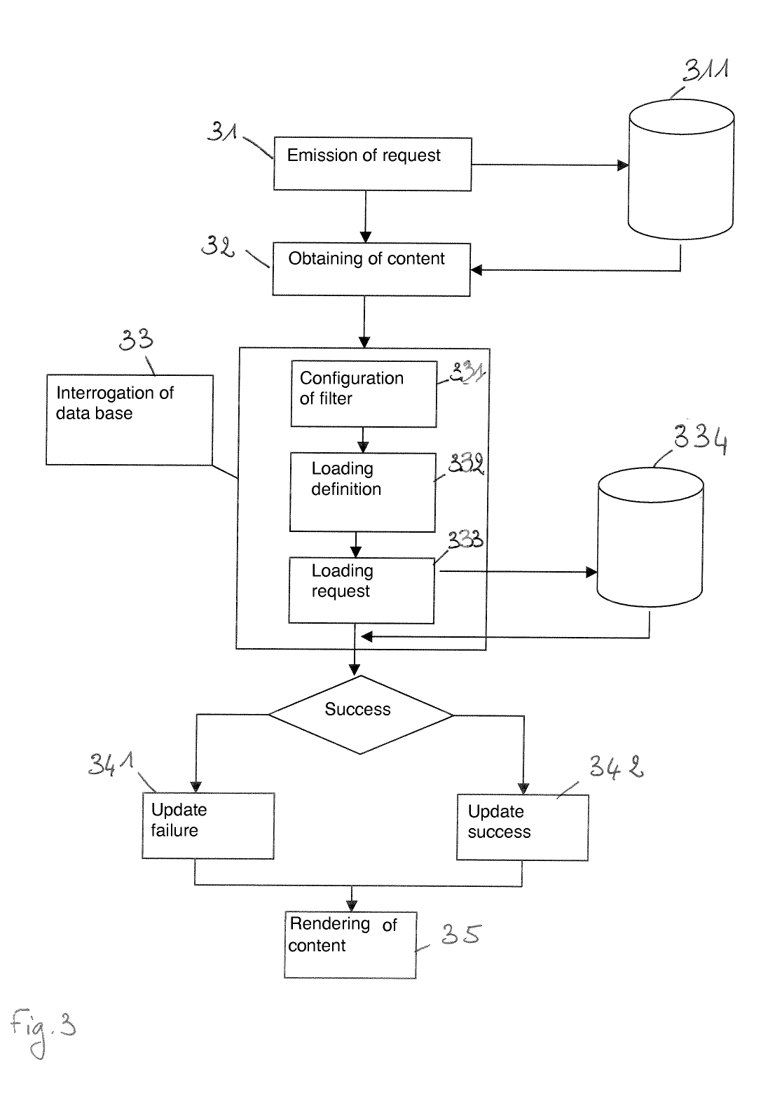

In one specific implementation mode of an embodiment of the invention, in a system where the structured information base is a base of information on televised programs that may be used to form an electronic program guide, contents such as those presented in FIG. 2 may be advantageously used to create the program guide.

Part (a) on the left hand side of FIG. 2 presents a program presentation screen. Part (b) on the right hand side of FIG. 2 presents a presentation screen of a summarised version of the presentation of two programs from a list of programs.

The use of the content of part (a) according to an embodiment of the invention is as follows.

In the graphic or text element content, wherein certain fields are designed to be replaced by information from the structured information base, there are: the service name, the service logo, the program presentation image, the program name, the start and end times of the program and the name of the following program.

In the structured information base there is for each program at least part of the above information. The purpose of the method described by an embodiment of the invention is to transfer this information from the base to the presentation:
a first command of the type cmd://Cbms_filterDef as presented in Appendix A, is present in the content to position a filter on the information base: for example, the content is provided to present the current day's sport programs. The first command is therefore a filter which restricts the field of application to “sport” type programs at today's date. There may be a certain number of programs in this restricted field. A second command of the cmd://cbms_loadID type, as presented in Appendix A, is present in the content to load in this content, among programs corresponding to the filter, detailed information on the first program, i.e. the service name, logo, image, the name of the program, the times and the following program.
if there is a sport program on the current day, then a third command of the cmd://cbms_getattr type, as defined in Appendix A, is present in the content to transfer the information loaded by the second command to the relevant fields of the presentation: the character string of the name of the service will replace the <name of service> character string in the presentation content, the service logo and the characteristic image of the program will be placed in the content, the program names, times and following program will respectively replace the character strings <Name Prg>, <Prg end time>, <Next name> and <next start time>.

An incrementation mechanism permits the same content to be used in the next invocation of this content in the following program in the list of programs responding to the “sport” and “today” filter.

For part (b) of FIG. 2, the positioning of the filter may be the same. The second command cmd://cbms_loadID will relate to the name and logo of the two programs. The third command cmd://cbms_getattr will replace the <Name> texts and the <Logo> images with the names of the two programs concerned and their logo. The “previous” and “next” elements are interactive buttons which offset the content in the list of programs concerned by the filter.

### APPENDIX A

### New Proposed Instructions

### 1—List of New Commands

### 1.1 Arithmetic Commands

SET
cmd://var set?name=variableName&value=X

->which defines and/or positions the value of a variable
ADD
cmd://var add?name=variableName&value=X

->which adds X to the value of a variable.
SUB
cmd://var sub?name=variableName&value=X

->which subtracts X from the value of a variable.

### 1.2 CBMS Commands and Request Definition

cmd://Cbms_filterDef?name<filtername&expr=expression

Where:
“name” corresponds to a name which permits this filter to be referenced subsequently;
“expr” is an expression in a request language understood by the CBMS parser.

Words with the suffix $ refer to Text nodes, they are to be replaced by the value of the node corresponding to the execution of the request.

Within the scope of an embodiment of the invention, a plurality of new additional requests is also defined, as follows:

AllServices: all of the services commanded from a service number;

AllTv: all of the TV (television) type services commanded from a service number;

Allradio: all of the radio type services commanded from a service number;

NOW: all of the services being commanded from a service number;

NEXT: all of the services concerned by a new command attached to a service number.

### 1.3 Loading of IDS of Elements Based on a Filter

The following commands permit an ID block to be loaded into the scene according to a given filter, and to activate the nodes in function of the existence or not of part of an ID block.

### 1.3.1 Value Indexed

The command indexed by value permits an atomic command at scene level to load a coherent data set.

Consequently, n elements are accessed corresponding to a given filter, in order to recover the ID of these N elements and to trigger the nodes if there is an element or not.
cmd://cbms_loadID?type=agiventype&filter=filtername&index=variablen ame&idt=DEFS&ids=DEFS&idh=DEFS

Where:
“type” is a value, which may actually take on the “service” or “program” value (required).
“filter” is a reference to a previously defined filter (required).
“index” is a reference to a previously defined variable (required).
“idt” corresponds to a list of DEFs separated by a comma which will receive the values of the ID of the n elements according to the filter defined from an index (optional).
“ids” corresponds to a list of DEFs separated by a comma which will be started if there is an i^{th} value present in the request (optional).
“idH” corresponds to a list of DEFs separated by a comma which will be started if there is not an i^{th} value present in the request (optional).

### 1.3.2 ID Indexed

The command indexed by ID permits an atomic command at scene level to load a coherent data set.

This permits a data set to be loaded so that the element with the ID ID is at the place indicated by the delta value.
cmd://cbms_loadID?filter=filtername&type=agiventype&idindex=id&delt a=avalue&idt=DEF&I ds=DEF&idh=DEFS

Where:
“type” is a value, which may actually take on the “service” or “program” value (required).
“filter” is a reference to a previously defined filter (required).
“idindex” is an ID (required).
“delta” is the offset desired for the ID of the request.
“idt” corresponds to a list of DEFs separated by a comma which will receive the values of the ID of the n elements according to the filter defined from an index (optional).
“ids” corresponds to a list of DEFs separated by a comma which will be started if there is an i^{th} value present in the request (optional).
“idH” corresponds to a list of DEFs separated by a comma which will be started if there is not an i^{th} value present in the request (optional).

### 1.4 Recovery of the Value of an Element

Permits an attribute of a scene to be valued from the value of an attribute of an element that is addressed by means of its identifier.
cmd://cmbs_getattr type=agiventype&name=atributeName&target=DEF&IDS=DEF&IDH=DEF&ID=agivenID&format=idformat

Where:
“type” is a value, which may actually take on the “service” or “program” values (required).
“name” is the name of the attribute to be retrieved (required).
“target” is the DEF of the node onto which the attribute will be placed if it is found (optional).
“ids” is the DEF of the node that will be run if an attribute is found that has a defined value (optional).
“idH” is the DEF of the node that will be run if an attribute is not found of it its value is not defined (optional).
“ID” is the ID of the element in question (required).
“format” (optional) corresponds to formatting of the attribute, no formatting if it is absent.

### 1.5 Testing the Value of an Element

This permits the value of an attribute of a given element to be tested.
cmd://cbms_testattr ?type=agiventype&name=atributeName&value=avalue&IDS=DEF&IDH=DEF&ID=agivenID&format=idformat

Where:
“type” is a value, which may actually take on the “service” or “program” values (required).
“name” is the name of the attribute to be retrieved (required).
“value” is the value to which the attribute is to be compared.
“ids” is the DEF of a node that will be run if the test is positive. (optional)
“idH” is the DEF of a node that will be run if the test is negative or if there is no value (optional).
“ID” is the ID of the element in question (required).
“format” (optional) corresponds to formatting of the attribute, no formatting if it is absent.

### 2—Abstraction of the Structure

The complex CBMS structure is abstracted for the scene level so that consequently only service type or program type element information is handled.

It is the role of the “CBMS presenter” to abstract the complexity of the internal data structure.

Service:
short name
name
description
serviceNumber
serviceID
sdp
logo
freetoAir
cleartoair

Program:
Start
End
Duration
serviceId
name
description
theme
parentalrating

(The case and lists of attributes are provided as illustration and are not restrictive).

### CONCLUSION

An embodiment of the invention provides a simple mechanism or technique for managing structure data in a graphic scene that:
is generic in terms of its implementation;
may be integrated into any graphic representation in a non-compiled form, that no longer requires, like the solutions known from the prior art, the use of a script interpreter such as ECMAScript, for example, or even a virtual JAVA (registered trade mark) to be run;
allows a system to be implemented which anticipates the management of the structured information, so as to optimise the hardware resources required to process the application.

An embodiment of the invention provides such a technique, that is simple and cheap to implement, whilst also permitting the various following technical problems to be addressed:
the management of the volume of information in the structured information base used by the graphic rendering motor in the graphic scenes.
the anticipation of one or more requests for the valorisation of graphic objects and interaction on the behaviour of graphic objects.
the temporary saving of the state of the structured information base in relation to the state of the graphic scene at a given instant.
the minimising of the processing on the structured information base and on the structured information so as to optimise the graphic rendering result.

A technical advantage of an embodiment of the invention may be resumed in the following three main technical points:
reduction of the memory used;
gain in the use of calculation resources;
compatibility with the usual decoding techniques.

An embodiment of the invention further permits structured information that may be collected from a specific content server to be taken into account for a graphic animation content, without any constraints in terms of programs or design on the player used on the client receiver terminal.

An embodiment of the invention provides a technique that permits a block of structured information to be taken into account for the description of the multi-media scene, or in the description of a graphic animation content and thus to avoid any risk of desynchronisation of information such as with the techniques known from the prior art.

An embodiment of the invention provides such a technique that permits any modification constraints of the player dedicated to playing the graphic animation content or multi-media scene to be dispensed with, or even further any reprogramming constraints.

Although the present disclosure has been described with reference to one or more examples, workers skilled in the art will recognize that changes may be made in form and detail without departing from the scope of the disclosure and/or the appended claims.

1. Method for rendering a graphic animation content comprising the following steps, in a receiver terminal:
emitting a request to retrieve said content;
obtaining at least one graphic scene of said content, describing at least a spatio-temporal arrangement between graphic objects of said content, wherein said content also comprises at least one function for managing structured information which permits interaction with a structured information data base;
interrogation of said data base, according to at least one command present in said graphic scene and associated to said structured information management functions;
obtaining structured information from said data base;
integration of said structured information into said graphic scene;
rendering of said graphic scene.

2. Method for rendering a graphic animation content according to claim 1, wherein at least one of said content and/or said structured information are stored in said terminal.

3. Method for rendering a graphic animation content according to claim 1, wherein at least one of said content and/or said structured information are stored on at least one remote server.

4. Method for rendering a graphic animation content according to claim 3, wherein said structured information is stored on a dedicated server, distinct from content server(s).

5. Method for rendering a graphic animation content according to claim 1, wherein the method comprises configuring a filter, initiated by one of said commands, which defines a sub-assembly of said structured information data base, comprising the information that needs to be presented.

6. Method for rendering a graphic animation content according to claim 5, wherein the method comprises at least one loading step, initiated after the filter configuration step, which defines a nature and a number of items of structured information data to be loaded.

7. Method for rendering a graphic animation content according to claim 6, wherein said loading step is preceded by positioning an index, initiated by a command which defines a loading order for the structured information data to be loaded.

8. Method for rendering a graphic animation content according to claim 6, wherein the method comprises:
detecting successful loading of the structured information data, generating success information;
updating said content upon receipt of the success information.

9. Method for rendering a graphic animation content according to claim 8, wherein said updating step comprises attributing data loaded to a field of an object of said graphic scene.

10. Method for rendering a graphic animation content according to claim 8, wherein the method comprises, in the case of detection of the success of a last item of data to be loaded, a step of adding into said graphic scene an interactive signal element which permits a user of said terminal to receive a signal that it is possible to load additional structured information data.

11. Method for rendering a graphic animation content according to claim 8, wherein the method comprises, in the case of a failure of the loading of the structured information data being detected, a step of updating said content, providing an item of information that is representative of said failure.
